(19) United States
(12) Patent Application Publication
(10) Pub. No.: US 2011/0238249 A1
(43) Pub. Date: Sep. 29, 2011

(54) MODULAR DRIVE BRUSHLESS DC MOTOR

(76) Inventor: Anil Ananthakrishna, Norcross, GA (US)

(21) Appl. No.: 13/069,433

(22) Filed: Mar. 23, 2011

Related U.S. Application Data
(60) Provisional application No. 61/316,422, filed on Mar. 23, 2010.

(51) Int. Cl. B60W 20/00; H02P 6/14; B60W 10/04; B60W 10/18

(52) U.S. Cl. 701/22; 318/400.26; 180/65.265

(57) ABSTRACT

A modular drive brushless DC motor is disclosed. In one embodiment, a modular drive brushless DC motor includes a rotor having permanent magnets disposed on the inner surface of the rotor, and a plurality of stators mounted on a stator shaft, where each of the plurality of stators having stator windings wound thereon facing the permanent magnets. The modular drive brushless DC motor also includes a plurality of slave control and commutation units for commutating the plurality of stators and for controlling amount of current and voltage supplied to the plurality of stators. Moreover, the modular drive brushless DC motor includes a master control unit operatively coupled to the plurality of slave control and commutation units for individually actuating the plurality of slave control and commutation units to cause generation of desired torque and speed at the rotor.

### CLAIMS OF PRIORITY

Benefit is claimed under 35 U.S.C. 119(e) to U.S. Provisional Application Ser. No. 61316422, entitled “TRACTION DRIVE SYSTEM FOR AN ELECTRIC VEHICLE” by Anil Ananthakrishna, filed on Mar. 23, 2010, which is herein incorporated in its entirety by reference for all purposes.

### TECHNICAL FIELD

The present disclosure generally relates to the field of DC motors, and more particularly relates to a brushless DC motor.

### BACKGROUND

Brushless DC motors consist of a permanent magnet rotor with a three phase stator winding. The advantage of brushless DC motor is that it offers longer life and less maintenance than conventional brush DC motors. One type of brushless DC motor use Hall-Effect sensors to measure the position of the rotor. Hall-Effect sensors provide the absolute position information required to commutate the motor. Another type of the brushless DC motor includes sensorless, brushless DC motor that does not have Hall-Effect sensors and employs electronics circuitry to control the commutation of the motor.

A control system coupled to a brushless DC motor for performing event management and controlling current, speed and commutation to the brushless DC motor. Typically, the control system employs a micro-controller to perform the above functions of the control system. For example, in a 350-2000 watts brushless DC motor, an 8 to 16-bit microcontroller efficiently optimizes control of the system's performance both for event management and for closed loop control of current, speed and commutation. Any more power than 2000 watts demands for a high end processor with higher execution speed and high capacity switching devices, which makes the brushless DC motor quite expensive. Paralleling of switching devices has its own challenges and does not provide for a fail proof solution. Paralleling of up to four switching devices for load sharing at high frequency is being practiced without any major issues, any more than this number of paralleling devices for load sharing may call for trouble.

### SUMMARY

This summary is provided to comply with 37 C.F.R. §1.73, requiring a summary of the invention briefly indicating the nature and substance of the invention. It is submitted with the understanding that it will not be used to interpret or limit the scope or meaning of the claims.

A modular drive brushless DC motor is disclosed. In one aspect, a modular drive brushless DC motor includes a rotor having permanent magnets disposed on the inner surface of the rotor, and a plurality of stators mounted on a stator shaft, where each of the plurality of stators having stator windings wound thereon facing the permanent magnets. The modular drive brushless DC motor also includes a plurality of slave control and commutation units for commutating the plurality of stators and for controlling amount of current and voltage supplied to the plurality of stators. Moreover, the modular drive brushless DC motor includes a master control unit operatively coupled to the plurality of slave control and commutation units for individually actuating the plurality of slave control and commutation units to cause generation of desired torque and speed at the rotor.

In another aspect, a modular drive brushless DC motor includes a plurality of stators mechanically coupled to each other, where each of plurality of stators having stator windings wound on an inner surface of said each of the plurality of stators. The modular drive brushless DC motor also includes a plurality of rotors mounted on a rotor shaft, where each of the plurality rotors has a plurality of permanent magnets disposed on the outer surface of said each of the plurality of rotors facing the respective stator windings of said each of the plurality of stators.

Furthermore, the modular drive brushless DC motor includes a plurality of slave control and commutation units for commutating the plurality of stators and for controlling amount of current and voltage supplied to the plurality of stators. Moreover, the modular drive brushless DC motor includes a master control unit operatively coupled to the plurality of slave control and commutation units for individually actuating the plurality of slave control and commutation units to cause generation of desired torque and speed at the output of the rotor shaft.

In yet another aspect, a traction drive system for an electric/hybrid vehicle includes a plurality of modular motors operable to drive a vehicle. Each of the plurality of modular motors includes one or more stators mechanically coupled to each other, where each of one or more stators having stator windings wound on an inner surface of said each of the one or more stators, and one or more rotors mounted on a rotor shaft, where each of the one or more rotors has a plurality of permanent magnets disposed on the outer surface of said each of the one or more rotors facing the respective stator windings of said each of the one or more stators.

The traction drive system also includes a plurality of slave control and commutation units for commutating the plurality of modular motors and for controlling amount of current and voltage supplied to the plurality of modular motors. Moreover, the traction drive system includes a master control unit operatively coupled to the plurality of slave control and commutation units for individually actuating the plurality of slave control and commutation units to cause generation of desired torque and speed at the output of the plurality of modular motors.

Other features of the embodiments will be apparent from the accompanying drawings and from the detailed description that follows.

### BRIEF DESCRIPTION OF THE VIEWS OF DRAWINGS

FIG. 1 illustrates a schematic diagram of a modular drive brushless DC motor with single rotor and multiple stators, according to one embodiment.

FIG. 2 is a schematic diagram of a modular drive brushless DC motor having multiple stators and multiple rotors, according to another embodiment.

FIG. 3 illustrates a schematic diagram of a traction drive system for a hybrid vehicle, according to one embodiment.

FIG. 4 is a block diagram illustrating various components of the traction drive system, according to one embodiment.

The drawings described herein are for illustration purposes only and are not intended to limit the scope of the present disclosure in any way.

### DETAILED DESCRIPTION

A modular drive brushless DC motor is disclosed. The following description is merely exemplary in nature and is not intended to limit the present disclosure, applications, or uses. It should be understood that throughout the drawings, corresponding reference numerals indicate like or corresponding parts and features.

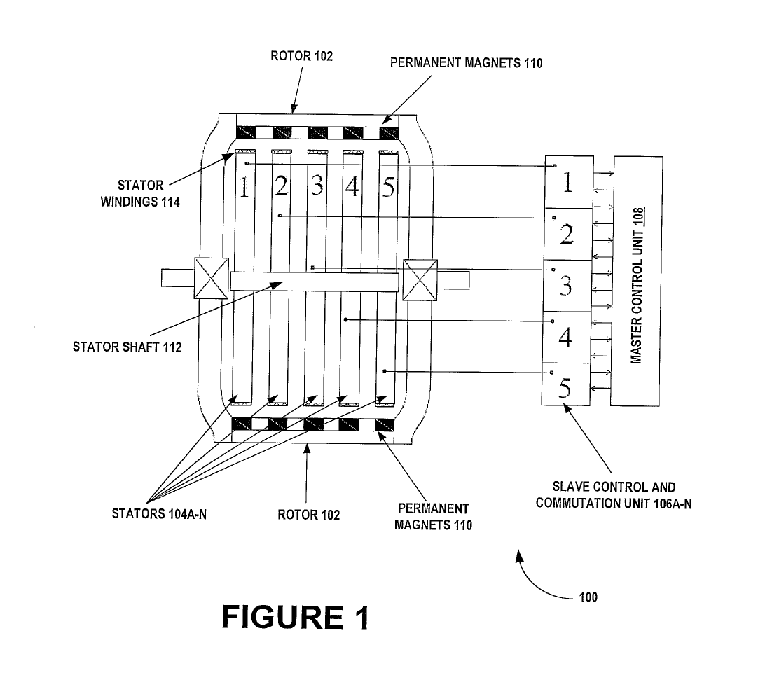

FIG. 1 illustrates a schematic diagram of a modular drive brushless DC motor 100 with single rotor 102 and multiple stators 104A-N, according to one embodiment. The modular drive brushless DC motor 100 includes a rotor 102, multiple stators 104A-N, slave control and commutation units 106A-N, and a master control unit 108.

The rotor 102 includes permanent magnets 110 disposed on the inner surface of the rotor 102. In some embodiments, the rotor 102 includes multiple sets of permanent magnets, each of the sets includes a number of N and S poles disposed alternatively in a circumferential direction on the inner surface of the rotor 102. In these embodiments, the N and S poles in the multiple sets are arranged in such a way that an axial misalignment is maintained between each N or S pole of a set and corresponding N or S pole of the adjacent set of permanent magnets. It is appreciated that, the number of poles or permanent magnets in each of the multiple sets is equal to 2P, where P any number greater than zero.

The stators 104A-N are mounted on a stator shaft 112, each of the stators 104A-N includes stator windings 114 wound thereon such that the stator windings 114 face the permanent magnets 110 disposed on the inner surface of the rotor 102. According an embodiment of the present invention, each of the stators 104A-N has unique torque-speed characteristics. It is appreciated that, the stators 104A-N are disposed coaxially with the rotor 102 and inside of the permanent magnets 110 so as to maintain an air gap between each of the stators 104A-N and the permanent magnets 110.

Each of the slave control and commutation units 106A-N includes a micro-controller and is electrically coupled to corresponding one of the stators 104A-N in order to individually control amount of current and voltage supplied to each of the stators 104A-N. Also, each of the slave control and commutation units 106A-N is operable for commutating respective one of the stators 104A-N. The master control unit 108 controls actuation of the slave control and commutation units 106A-N such that necessary torque and speed is generated by rotation of the rotor 102.

In an exemplary operation, the master control unit 108 individually actuates the slave control and commutation units 106A-N with respect to torque and speed desired at the output of the rotor 102. Accordingly, one or more of the slave control and commutation units 106A-N provides desired commutation, current and voltage to the respective one of the stators 104A-N to cause the rotor 102 to rotate at a desired speed and generate desired output torque. It can be noted that, the desired speed and torque is obtained at the output of the rotor 102 due to the magnetic field generated between the stator windings 114 of the one or more stators 106A-N, that received current from the respective slave control and commutation units 106A-N, and the permanent magnets 110 of the rotor 102.

Desired torque speed characteristics can be achieved by actuation selected slave control and commutation units and by controlling the current and voltage supplied to respective stators. It is appreciated that, the master control unit 108 communicates with the slave control and commutation units 106A-N via a communication bus using analogue or digital signals. The master control unit 108 and the slave control and commutation units 106A-N may include control circuitry used to operate conventional single stator-rotor brushless DC motor and is well known to the person skilled in the art.

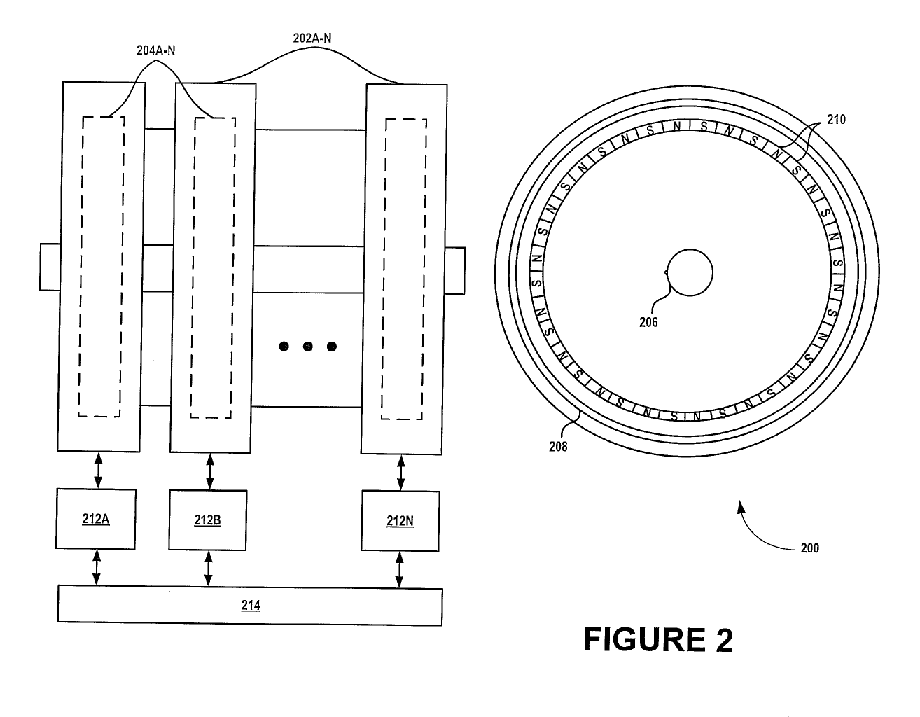

FIG. 2 is a schematic diagram of a modular drive brushless DC motor 200 having multiple stators 202A-N and multiple rotors 204A-N, according to another embodiment. In FIG. 2, the modular drive brushless DC motor 200 includes multiple rotors 204A-N that are mounted on a rotor shaft 206 and disposed coaxially with respect to the stators 202A-N.

Each of the stators 202A-N consists of stator windings 208 wound on the inner surface. Each of the rotors 204A-N consists of permanent magnets 210 disposed on the outer surface of each of the rotors 204A-N and facing the stator windings 208. The modular drive brushless DC motor 200 is similar to the modular brushless DC motor 100 except in the modular drive brushless DC motor 200 includes the rotors 204A-N acting as an in-runner (whereas the rotor 102 in FIG. 1 acts an out-runner). In one embodiment, each of the stator-rotor pair in the modular drive brushless DC motor 200 is operable to generate unique torque speed characteristics.

As explained above, the operation of the stator-rotor pair is controlled by an individual slave control and commutation unit, where each of the slave control and commutation units 212A-N is individually actuated by the master control unit 214 to cause generation of desired torque and speed at the rotor shaft 206.

It can be noted that, the modular drive brushless DC motors 100 and 200 may use sensor(s) or sensorless electronics circuitry well known in the art to determine position information of rotor(s) required to commutate the stator(s). One skilled in the art will realize the modular drive brushless motors 100 and 200 can have various applications (e.g., requiring varying torque and speed) including but not limited to a traction drive system of a hybrid vehicle or a pure electric vehicle.

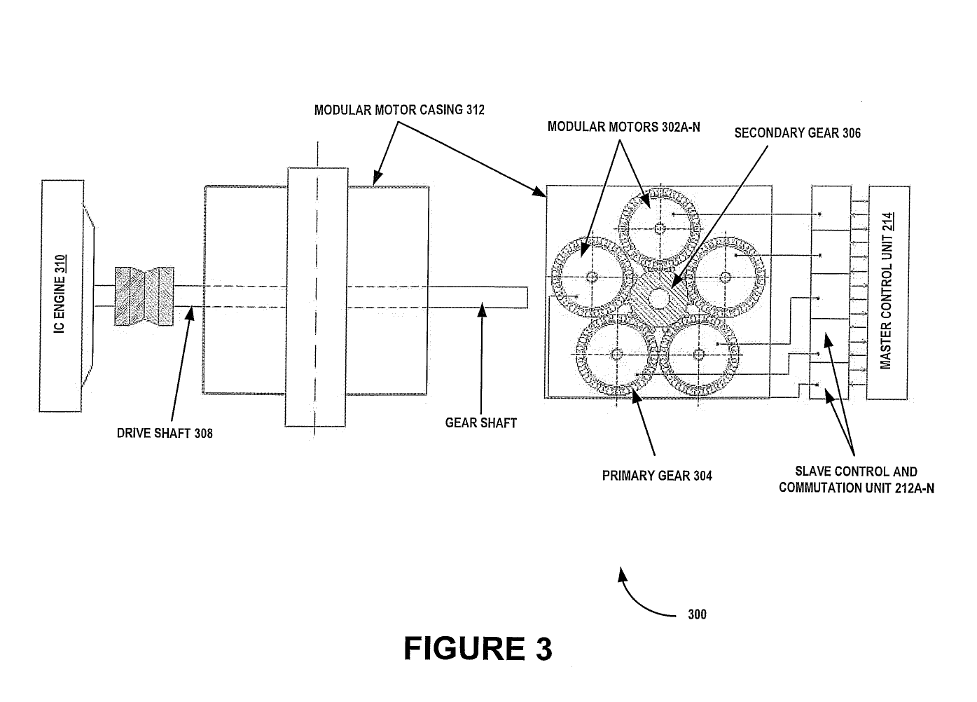

FIG. 3 illustrates a schematic diagram of a traction drive system 300 for a hybrid vehicle, according to one embodiment. In FIG. 3, the traction drive system includes modular motors 302A-N, a slave control and commutation units 212A-N, and a master control unit 214. Each of the modular motors 302A-N includes one or more stators 202A-N mechanically coupled to each other, and one or more rotors 204A-N mounted on a rotor shaft 206. As shown, the modular motors 302A-N are housed in a modular motor casing 312. It is appreciated that, each of the modular motors 302A-N is an exemplary embodiment of the modular drive brushless DC motor 200 of FIG. 2.

The slave control and commutation units 212A-N are electrically coupled to each of the modular motors 302A-N for controlling current and voltage supplied to the plurality of modular motors 302A-N. The master control unit 214 is operatively coupled to the slave control and commutation units 212A-N for individually actuating the slave control and commutation units 212A-N to cause generation of desired torque and speed at the output of the modular motors 302A-N. The output shaft of each of the modular motors 302A-N is coupled to a primary gear 304 which meshes with a secondary gear 306 to provide desired torque and speed generated by respective one of the modular motors 302A-N. The secondary gear 302 provides uses the torque and speed to drive an IC engine 310 or wheels of the hybrid vehicle. For example, a transmission mechanism (chain-sprocket, planetary gear, etc.) may be employed to transform speed and torque from individual output shafts of the modular motors 302A-N to a drive shaft 308 of the hybrid vehicle. It is understood that, the above traction drive system 300 can also implemented in pure electric vehicles.

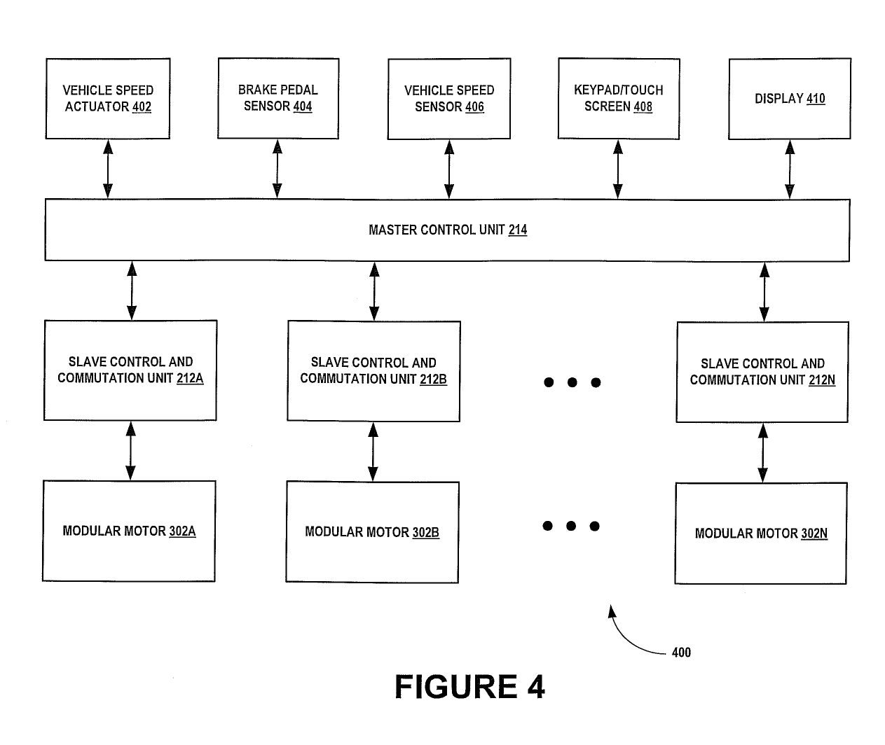

FIG. 4 is a block diagram 400 illustrating various components of the traction drive system 300, according to one embodiment. As discussed above, the master control unit 214 actuates one or more of the slave control and commutation units 212A-N based on the desired torque speed characteristics. For determining the desired torque-speed characteristics, the master control unit 214 may collect inputs from various components of the hybrid vehicle.

For example, the master control unit 214 may receive signals to increase the speed of the hybrid vehicle from a vehicle speed actuator 402 coupled to the master control unit 214. Also, a brake pedal sensor 404 coupled to the master control unit 214 may provide signals to retard the speed of the hybrid vehicle upon actuation of a brake pedal of the hybrid vehicle. Furthermore, the master control unit 214 may receive vehicle speed information from a vehicle speed sensor(s) 406. Moreover, the master control unit 214 may receive a change in performance parameters and mode of operation through a keypad/touch screen 408.

Additionally, the master control unit 214 may provide vehicle parameters to a display 410 mounted on a dashboard of the hybrid vehicle. Exemplary parameters may include working state of the slave control and commutation units 212A-N, speed of the hybrid vehicle, energy consumed, energy drawn, vehicle performance, and so on.

It will be recognized that the above described invention may be embodied in other specific forms without departing from the spirit or essential characteristics of the disclosure. Thus, it is understood that, the invention is not to be limited by the foregoing illustrative details, but it is rather to be defined by the appended claims.

What is claimed is:

1. A modular drive brushless DC motor comprising:
a rotor having a plurality of permanent magnets disposed on the inner surface of the rotor;
a plurality of stators mounted on a stator shaft, wherein each of the plurality of stators having stator windings wound thereon facing the permanent magnets;
a plurality of slave control and commutation units for commutating the plurality of stators and controlling amount of current and voltage supplied to the plurality of stators; and
a master control unit operatively coupled to the plurality of slave control and commutation units for individually actuating the plurality of slave control and commutation units to cause generation of desired torque and speed at the rotor.

2. The modular drive brushless DC motor of claim 1, wherein each of the plurality of slave control and commutation units is operable for controlling amount of current and voltage provided to one of the plurality of stators.

3. The modular drive brushless DC motor of claim 1, wherein each of the plurality of slave control and commutation units is operable for commutating one of the plurality of stators.

4. The modular drive brushless DC motor of claim 2, wherein each of the plurality of stators are operable for generating a unique torque-speed characteristics at the rotor based on the current and voltage supplied by the associated one of the plurality of slave control and commutation units.

5. The modular drive brushless DC motor of claim 1, wherein the rotor comprises multiple sets of permanent magnets, wherein each of the multiple sets of permanent magnets comprises a number of N and S poles disposed alternatively in a circumferential direction on the inner surface of the rotor.

6. The modular drive brushless DC motor of claim 5, wherein the number of N and S poles of each of the multiple sets of permanent magnets are axially misaligned with respect to the N and S poles of the adjacent set of the multiple sets of permanent magnets.

7. A modular drive brushless DC motor comprising:
a plurality of stators mechanically coupled to each other, each of plurality of stators having stator windings wound on an inner surface of said each of the plurality of stators;
a plurality of rotors mounted on a rotor shaft, each of the plurality rotors has a plurality of permanent magnets disposed on the outer surface of said each of the plurality of rotors facing the respective stator windings of said each of the plurality of stators;
a plurality of slave control and commutation units for commutating the plurality of stators and for controlling amount of current and voltage supplied to the plurality of stators; and
a master control unit operatively coupled to the plurality of slave control and commutation units for individually actuating the plurality of slave control and commutation units to cause generation of desired torque and speed at the output of the rotor shaft.

8. The modular drive brushless DC motor of claim 7, wherein each of the plurality of slave control and commutation units is operable for controlling amount of current and voltage provided to one of the plurality of stators.

9. The modular drive brushless DC motor of claim 7, wherein each of the plurality of slave control and commutation units is operable for commutating one of the plurality of stators.

10. The modular drive brushless DC motor of claim 8, wherein each of the plurality of stators are operable for generating a unique torque-speed characteristics at the output of the rotor shaft based on the current and voltage supplied by the associated one of the plurality of slave control and commutation units.

11. The modular drive brushless DC motor of claim 7, wherein each of the plurality of the rotors comprises multiple sets of permanent magnets, wherein each of the multiple sets of permanent magnets comprises a number of N and S poles disposed alternatively in a circumferential direction on the outer surface.

12. The modular drive brushless DC motor of claim 11, wherein the number of N and S poles of each of the multiple sets of permanent magnets are axially misaligned with respect to the N and S poles of adjacent set of the multiple sets of permanent magnets.

13. A traction drive system for an electric/hybrid vehicle, comprising:
a plurality of modular motors operable to drive a vehicle, wherein each of the plurality of modular motors comprises:
one or more stators mechanically coupled to each other, each of one or more stators having stator windings wound on an inner surface of said each of the one or more stators; and
one or more rotors mounted on a rotor shaft, each of the one or more rotors has a plurality of permanent magnets disposed on the outer surface of said each of the one or more rotors facing the respective stator windings of said each of the one or more stators;
a plurality of slave control and commutation units for commutating the plurality of modular motors and for controlling amount of current and voltage supplied to the plurality of modular motors; and
a master control unit operatively coupled to the plurality of slave control and commutation units for individually actuating the plurality of slave control and commutation units to cause generation of desired torque and speed at the output of the plurality of modular motors.

14. The system of claim 13, wherein each of the plurality of slave control and commutation units is operable for controlling amount of current and voltage provided to one of the plurality of modular motors.

15. The system of claim 13, wherein each of the plurality of slave control and commutation units is operable for commutating one of the plurality of modular motors.

16. The system of claim 14, wherein each of the plurality of modular motors are operable for generating a unique torque-speed characteristics at the output of the plurality of modular motors based on the current and voltage supplied by the associated one of the plurality of slave control and commutation units.

17. The system of claim 13, further comprises:
a vehicle speed actuator coupled to the master control unit for providing signals to increase the speed of the electric/hybrid vehicle;
a brake pedal sensor coupled to the master control unit for providing signals to retard the speed of the electric/hybrid vehicle upon actuation of a brake pedal of the electric/hybrid vehicle; and
a vehicle speed sensor coupled to the master control unit for providing vehicle speed information to the master control unit.

18. The system of claim 17, wherein the master control unit actuates one or more of the plurality of slave control and commutation units based on inputs from at least one of the vehicle speed actuator, the brake pedal sensor, and the vehicle speed sensor.

19. The system of claim 13, further comprising:
a display coupled to the master control unit for displaying one or more parameters associated with the traction drive system, wherein the one or more parameters comprises working state of each of the slave control and commutation units, energy drawn, and energy consumed.

20. The system of claim 13, wherein the plurality of modular motors are operable for providing varying torque and speed to an output drive shaft via a transmission mechanism.
